(19) United States
(12) Patent Application Publication
(10) Pub. No.: US 2016/0308398 A1
(43) Pub. Date: Oct. 20, 2016

(54) RECTIFYING CIRCUIT FOR HIGH-FREQUENCY POWER SUPPLY

(71) Applicant: MITSUBISHI ELECTRIC ENGINEERING COMPANY, LIMITED, Chiyoda-ku, Tokyo (JP)

(72) Inventors: Yoshiyuki Akuzawa, Chiyoda-ku (JP); Kiyohide Sakai, Chiyoda-ku (JP); Toshihiro Ezoe, Chiyoda-ku (JP); Yuki Ito, Chiyoda-ku (JP)

(73) Assignee: MITSUBISHI ELECTRIC ENGINEERING COMPANY, LIMITED, Chiyoda-ku, Tokyo (JP)

(21) Appl. No.: 15/102,111

(22) PCT Filed: Dec. 10, 2013
(86) PCT No.: PCT/JP2013/083097

§ 371 Date: Jun. 6, 2016

(51) Int. Cl. H02J 50/12

(52) U.S. Cl. CPC H02J 50/12

(57) ABSTRACT

Disclosed is a rectifying circuit for high-frequency power supply that rectifies an alternating voltage at a high frequency equal to or higher than 2 MHz, the rectifying circuit for high-frequency power supply including a class E rectifier circuit that rectifies the alternating voltage inputted from a reception antenna for power transmission 10, a resonant circuit that causes the class E rectifier circuit to perform resonant switching in a switching operation at the time of rectification, a matching functional circuit that has a function of matching a resonance condition to that of the reception antenna for power transmission 10, and a function of matching the resonance condition to that of the resonant circuit, and a smoothing functional circuit that smooths the voltage rectified by the class E rectifier circuit into a direct voltage.

### FIELD OF THE INVENTION

The present invention relates to a rectifying circuit for high-frequency power supply that rectifies an alternating current power supply at a high frequency.

### BACKGROUND OF THE INVENTION

A class E rectifier circuit according to a conventional technology, for use in rectification in a kHz band, is shown in FIG. 13. In this class E rectifier circuit, an inputted alternating voltage Vin of 200 kHz is rectified and converted into a direct voltage to be outputted (for example, refer to nonpatent reference 1).

### RELATED ART DOCUMENT

Nonpatent reference
Nonpatent reference 1: The 2013 Institute of Electronics, Information and Communication Engineers General Conference BCS-1-16

### SUMMARY OF THE INVENTION

### Problems to be Solved by the Invention

However, a problem is that when the conventional configuration is applied to the rectification at a high frequency equal to or higher than a MHz band, the power conversion efficiency is poor. Particularly, in a case where a circuit, such as a resonant type reception antenna, which has high frequency characteristics in its output impedance is connected to the input side, an influence is exerted upon the operation of the class E rectifier circuit itself, and an efficient power conversion operation which is an essential object cannot be maintained.

The power loss in the circuit which occurs at the time of the rectifying operation results in heat energy and hence a temperature rise of the circuit board. This results in an increase in the operating environment temperature of the circuit board and hence a reduction in the life of the used parts. Therefore, a measure, such as a measure of providing an exhaust heat device, is needed, and the conventional configuration also causes an increase in cost, upsizing, and an increase in mass.

The present invention is made in order to solve the above-mentioned problems, and it is therefore an object of the present invention to provide a rectifying circuit for high-frequency power supply that can provide a high power conversion efficiency characteristic in rectification of an alternating voltage at a high frequency equal to or higher than 2 MHz

### Means for Solving the Problem

According to the present invention, there is provided a rectifying circuit for high-frequency power supply that rectifies an alternating voltage at a high frequency equal to or higher 2 MHz, the rectifying circuit for high-frequency power supply including: a class E rectifier circuit that rectifies the alternating voltage inputted from a reception antenna for power transmission; a resonant circuit that causes the class E rectifier circuit to perform resonant switching in a switching operation at a time of rectification; a matching functional circuit that has a function of matching a resonance condition to that of the reception antenna for power transmission, and a function of matching the resonance condition to that of the resonant circuit; and a smoothing functional circuit that smooths the voltage rectified by the class E rectifier circuit into a direct voltage.

### ADVANTAGES OF THE INVENTION

Because the rectifying circuit for high-frequency power supply according to the present invention is configured as above, a high power conversion efficiency characteristic can be provided in the rectification of the alternating voltage at a high frequency equal to or higher than 2 MHz.

### BRIEF DESCRIPTION OF THE FIGURES

FIG. 1 is a diagram showing the configuration of a rectifying circuit for high-frequency power supply according to Embodiment 1 of the present invention;

FIG. 2 is a diagram showing another example of the configuration of the rectifying circuit for high-frequency power supply according to Embodiment 1 of the present invention;

FIG. 3 is a diagram showing another example of the configuration of the rectifying circuit for high-frequency power supply according to Embodiment 1 of the present invention;

FIG. 4 is a diagram showing another example of the configuration of the rectifying circuit for high-frequency power supply according to Embodiment 1 of the present invention;

FIG. 5 is a diagram showing another example of the configuration of the rectifying circuit for high-frequency power supply according to Embodiment 1 of the present invention;

FIG. 6 is a diagram showing another example of the configuration of the rectifying circuit for high-frequency power supply according to Embodiment 1 of the present invention;

FIG. 7 is a diagram showing another example of the configuration of the rectifying circuit for high-frequency power supply according to Embodiment 1 of the present invention;

FIG. 8 is a diagram showing another example of the configuration of the rectifying circuit for high-frequency power supply according to Embodiment 1 of the present invention;

FIG. 9 is a diagram showing another example of the configuration of the rectifying circuit for high-frequency power supply according to Embodiment 1 of the present invention;

FIG. 10 is a diagram showing another example of the configuration of the rectifying circuit for high-frequency power supply according to Embodiment 1 of the present invention (in a case in which a variable resonance condition LC circuit is disposed);

FIG. 11 is a diagram showing the configuration of the configuration of a rectifying circuit for high-frequency power supply according to Embodiment 2 of the present invention (in a case in which an FET is used instead of a diode);

FIG. 12 is a diagram showing another example of the configuration of the rectifying circuit for high-frequency power supply according to Embodiment 2 of the present invention (in a case in which a diode and an FET are used); and

FIG. 13 is a diagram showing the configuration of a conventional rectifying circuit for high-frequency power supply.

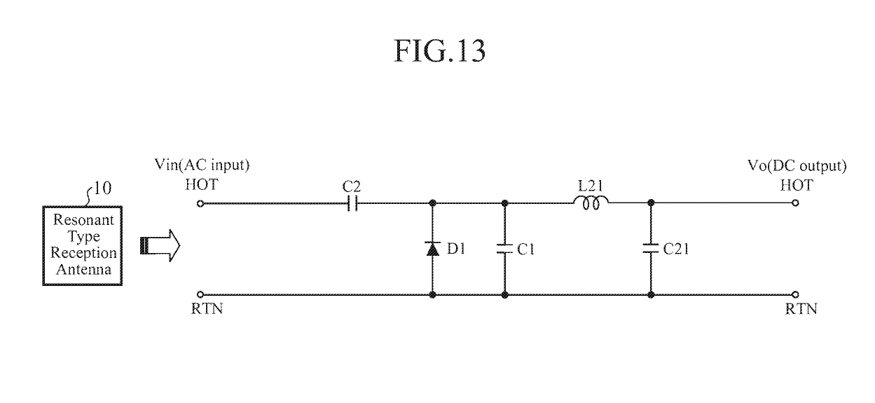

### EMBODIMENTS OF THE INVENTION

Hereafter, the preferred embodiments of the present invention will be explained in detail with reference to the drawings.

### Embodiment 1

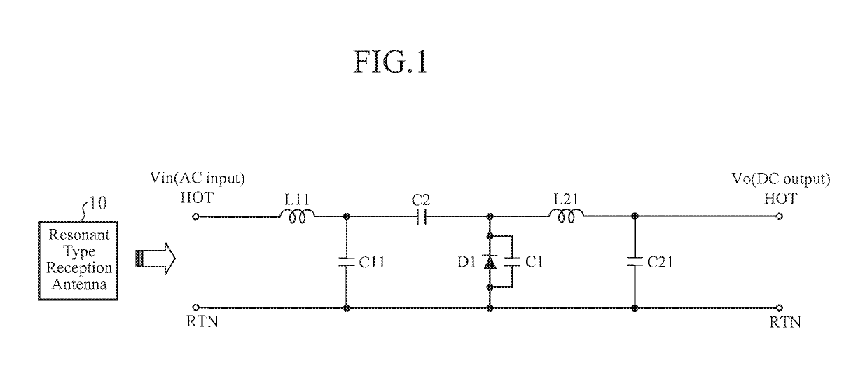

FIG. 1 is a diagram showing the configuration of a rectifying circuit for high-frequency power supply according to Embodiment 1 of the present invention.

The rectifying circuit for high-frequency power supply rectifies an alternating voltage Vin at a high frequency equal to or higher 2 MHz. This rectifying circuit for high-frequency power supply is configured with a diode D1, capacitors C1 and C2, an inductor L21, a capacitor C21, an inductor L11 and a capacitor C11, as shown in FIG. 1.

A resonant type reception antenna (a reception antenna for power transmission) 10 is a resonant type antenna for power transmission having LC resonance characteristics (which is not limited only to a noncontact type one). This resonant type reception antenna 10 can be of any of magnetic-field resonance type, electric-field resonance type, and electromagnetic induction type.

The diode D1 is a rectifying element that constructs a class E rectifier circuit for converting the alternating voltage Vin at a high frequency equal to or higher than 2 MHz, which is inputted from the resonant type reception antenna 10, into a direct voltage. As the diode D1, not only a diode for high frequency (RF; Radio Frequency) but also an element, such as a diode of, for example, Si type, SiC type or GaN type, or a Schottky barrier diode, can be used.

The capacitors C1 and C2 and the inductor L21 construct a resonant circuit for a class E rectifying operation in the diode D1 by a compound function. This resonant circuit causes the diode D1 to perform resonant switching in a switching operation at the time of rectification of the diode D1. The capacitor C1 is a constant that consists of either the parasitic capacitance of the diode D1 or a combined capacitance of the parasitic capacitance and the capacitance of a discrete element. Further, as the capacitor C2, a ceramic capacitor or a film capacitor or the like can be used. Further, as the inductor L21, an air-core coil, a magnetic material coil or the like can be used.

The capacitor C21 is an element that constructs a smoothing functional circuit for smoothing a ripple voltage after being rectified by the diode D1 into a direct voltage. As the capacitor C21, an element, such as a ceramic capacitor, a tantalum capacitor or a film capacitor, can he used.

The inductor L11 and the capacitor C11 are elements that construct a matching functional circuit having a function of performing impedance matching with the resonant type reception antenna 10 on an input side (matching the resonance condition to that of the resonant type reception antenna 10), and a function for performing impedance matching with the resonant circuit by the capacitors C1 and C2 and the inductor L21 (matching the resonance condition to that of the resonant circuit). As the inductor L11, an air-core coil, a magnetic material coil or the like can be used. In addition, as the capacitor C11, an element, such as a ceramic capacitor, a tantalum capacitor or a film capacitor, can be used. By virtue of the inductor L11 and the capacitor C11, a resonant switching operation can be implemented by the diode D1.

The rectifying circuit for high-frequency power supply according to the present invention is configured in this way so as to include the three functions (the matching function, the class E rectifying function and the smoothing function) in the single circuit configuration which is not established by using a circuit designing method of keeping those functions separated. Then, the rectifying circuit for high-frequency power supply has a function of performing matching with the output impedance of the resonant type reception antenna 10 and also performing matching with the impedance of the resonant circuit configured with the capacitors C1 and C2, and the inductor L21 by using a compound function according to the inductor L1 and the capacitor C11, and also has a function of performing the diode D1 to perform the resonant switching in the switching operation at the time of rectification by using the resonant circuit. As a result, the switching loss of the diode D1 is reduced.

Next, the operation of the rectifying circuit for high-frequency power supply configured as above will be explained.

First, when the alternating voltage Vin having a high frequency equal to or higher 2 MHz is inputted from the resonant type reception antenna 10, matching with the output impedance of the resonant type reception antenna 10 and impedance matching with the impedance of the resonant circuit configured with the capacitors C1 and C2, and the inductor L21 are achieved by the compound function according to the inductor L11 and the capacitor C11. Then, while the matching state is maintained, the inputted alternating voltage Vin is rectified into a ripple voltage having a one-sided electric potential (a positive electric potential) by the capacitor C2 and diode D1. At that time, because the switching operation by the diode D1 becomes resonant switching operation by virtue of the compound function according to the capacitors C1 and C2 and the inductor L21, and enters a ZVS (zero voltage switching) state. This state is a class E rectifying operation, so that the operation is implemented with a small switching loss. Then, the ripple voltage after being rectified is smoothed into a direct voltage by the capacitor C21, and the direct voltage is outputted.

Through the above-mentioned series of operations, the rectifying circuit for high-frequency power supply can rectify the inputted alternating voltage Vin having a high frequency into a direct voltage with high power conversion efficiency (equal to or greater than 90%) , and output the direct voltage.

As mentioned above, because the rectifying circuit for high-frequency power supply according to this Embodiment 1 is configured in such a way as to include the function of performing impedance matching with a circuit having a high frequency characteristic in its output impedance, such as the resonant type reception antenna 10, and the function of operating as a part of the resonance operation of the class E rectifier circuit thereof, the loss at the time of the rectifying operation at a high frequency equal to or higher than a MHz band can be greatly reduced, and high power conversion efficiency (efficiency of 90% or more) can be achieved.

Further, because the power loss in the circuit which occurs at the time of the rectifying operation is small, and hence the heat energy generated is also small and the temperature rise of the circuit board is suppressed to a low value, the influence of the operating environment temperature on the life of the used parts can be reduced. Therefore, measure, such as a measure of providing a conventional exhaust heat device, is not needed, and a cost reduction, downsizing, a weight reduction and low power consumption can be achieved.

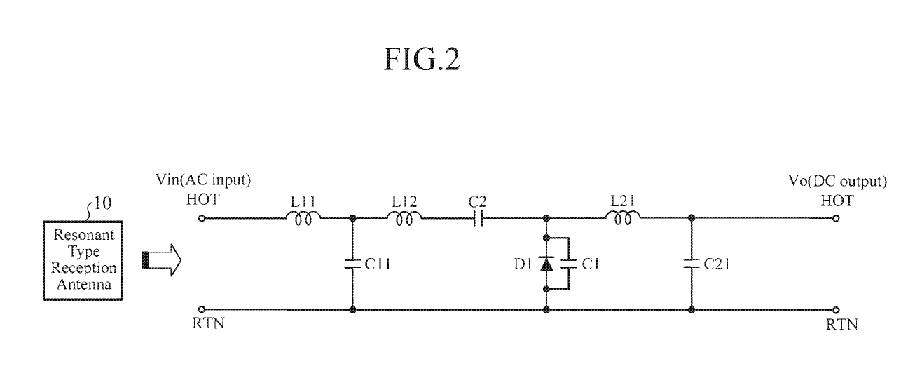

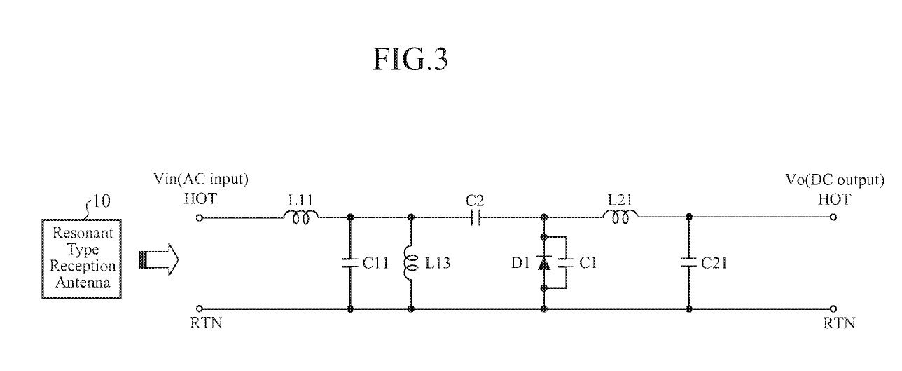

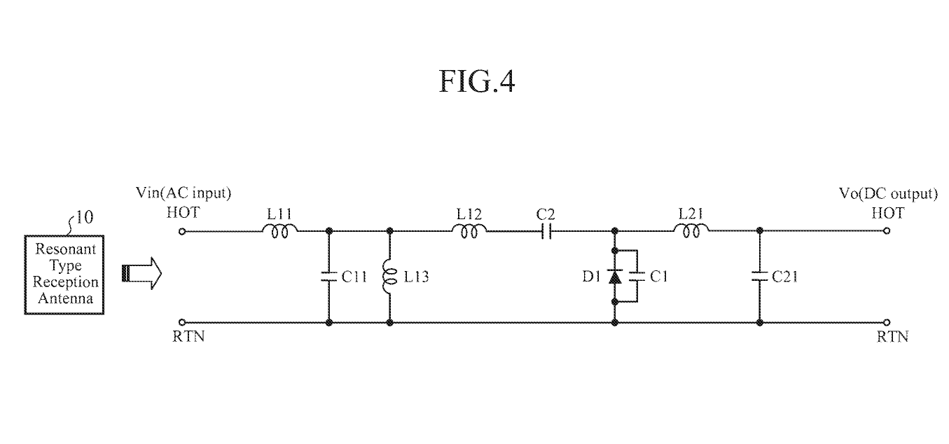

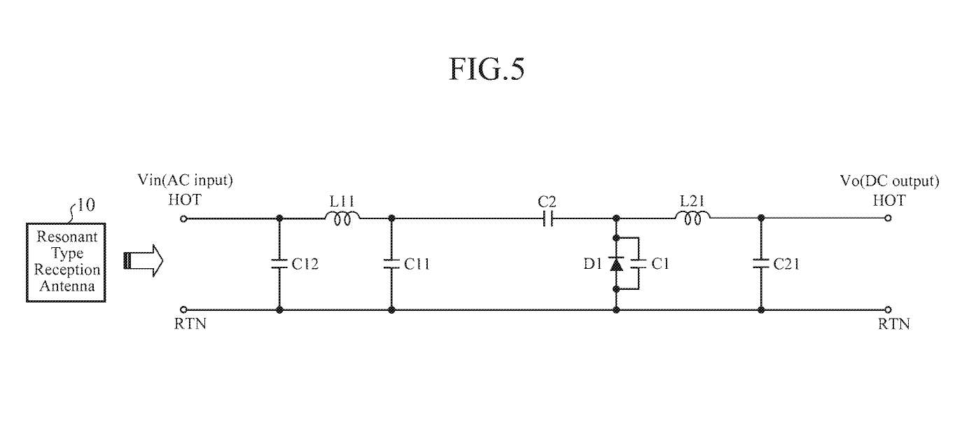

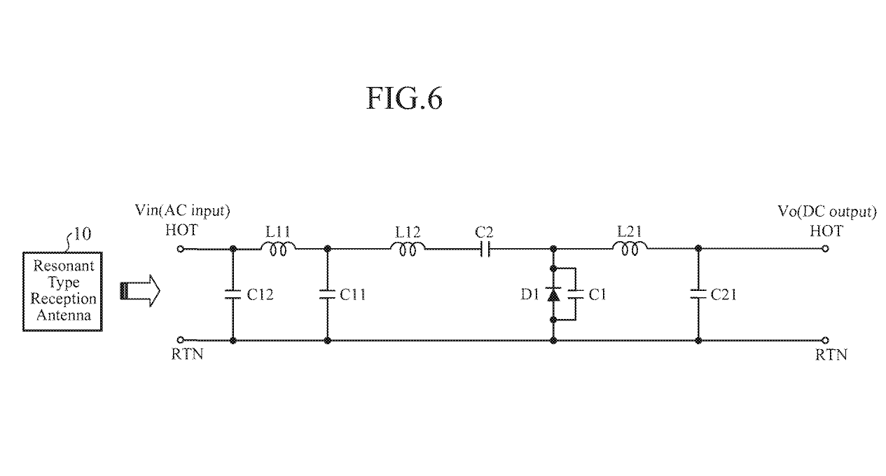

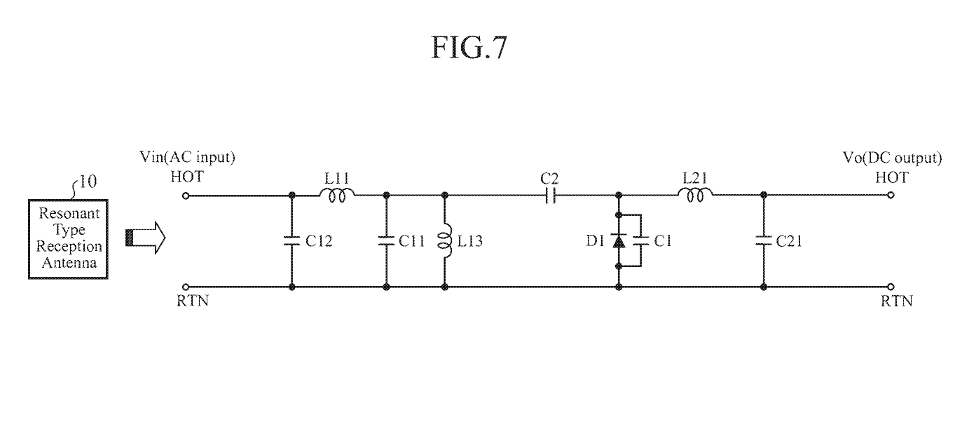

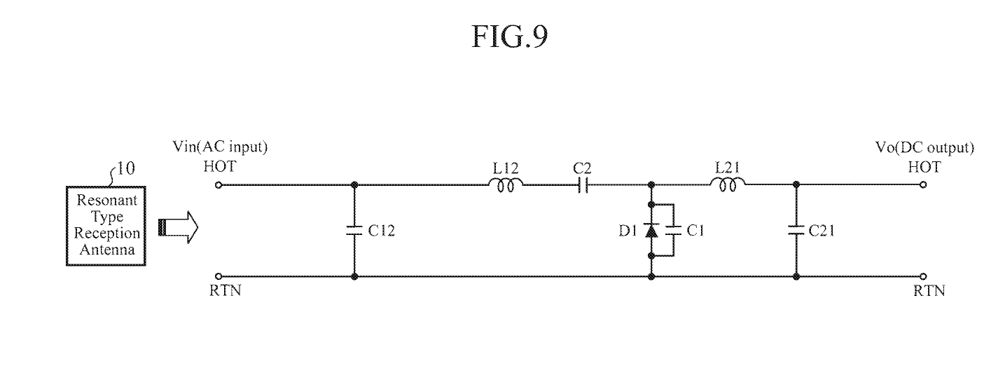

Incidentally, the case in which the rectifying circuit for high-frequency power supply is configured using the diode D1, the capacitors C1 and C2, the inductor L21, the capacitor C21, the inductor L11 and the capacitor C11 is shown in FIG. 1. However, this embodiment is not limited to this example. For example, the rectifying circuit for high-frequency power supply can have a configuration as shown in any one of FIGS. 2 to 9. In this case, the rectifying circuit for high-frequency power supply can have a configuration which is an optimal one selected from among the configurations shown in FIGS. 1 to 9 according to both the configuration (the output impedance) of the resonant type reception antenna 10, and the input impedance of a device which is connected to the output (DC output) of the rectifying circuit for high-frequency power supply.

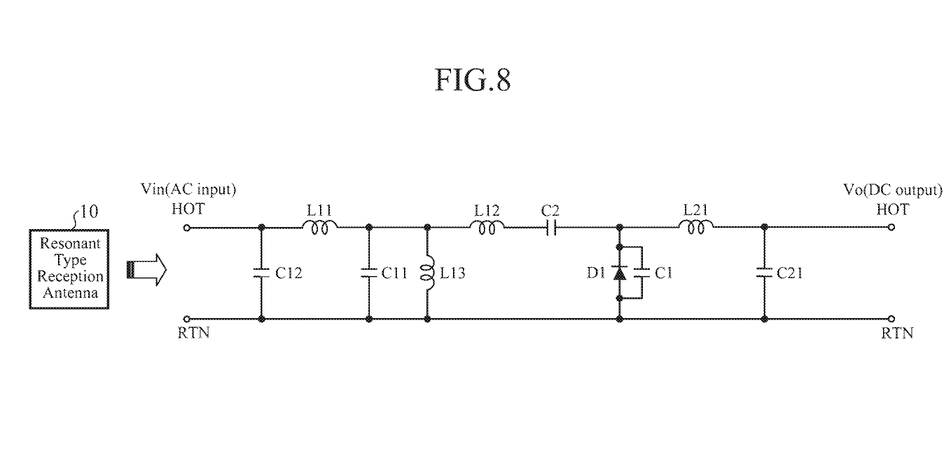

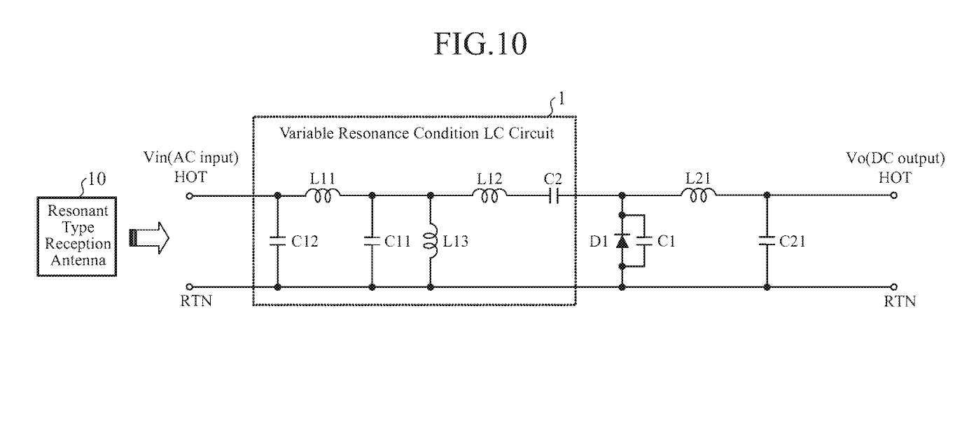

Further, although the explanation is made as to the example shown in FIG. 1 by assuming that the constants of the inductor L11 and the capacitor C11 which construct the matching functional circuit are fixed and that the resonance condition is fixed, this embodiment is not limited to this example. A variable resonance condition LC circuit 1 that causes the resonance condition to be variable can be used, as shown in, for example, FIG. 10. FIG. 10 shows an example in which the variable resonance condition LC circuit 1 is applied to the configuration shown in FIG. 8 and having the largest parts count among the configurations shown in FIGS. 1 to 9, and the variable range of the resonance condition is the widest. In the example of FIG. 10, the variable resonance condition LC circuit 1 causes the constants of the inductors L11, L12 and L13 and the capacitors C2, C11 and C12 to be variable.

The variable resonance condition LC circuit 1 can be applied similarly to the examples shown in FIGS. 1 to 7, and 9.

### Embodiment 2

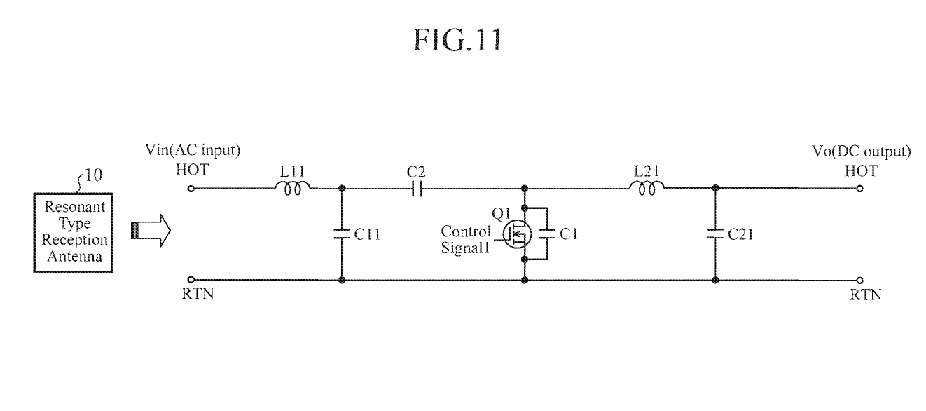

FIG. 11 is a diagram showing the configuration of a rectifying circuit for high-frequency power supply according to Embodiment 2 of the present invention. The rectifying circuit for high-frequency power supply according to Embodiment 2 shown in FIG. 11 is the one in which the diode D1 of the rectifying circuit for high-frequency power supply according to Embodiment 1 shown in FIG. 1 is replaced by a power element Q1. The other components are the same as those according to Embodiment 1 and are designated by the same reference character strings, and an explanation will be made as to only a different portion.

The power element Q1 is a rectifying element that constructs a class E rectifier circuit for converting an alternating voltage Vin at a high frequency equal to or higher than 2 MHz, which is inputted from a resonant type reception antenna 10, into a direct voltage. As the power element not only a field effect transistor for RF (FET: Field Effect Transistor) but also an element, such as a Si-MOSFET, a SiC-MOSFET or a GaN-FETs, can be used. A capacitor C1 consists of either the parasitic capacitance of the power element Q1 or a combined capacitance of the parasitic capacitance and the capacitance of a discrete element.

Even in the case in which the rectifying circuit for high-frequency power supply is configured using the power element Q1 in this way, instead of using the diode D1, the same advantages as those provided by Embodiment 1 can be provided.

The configuration in which the diode D1 shown in FIG. 1 is replaced by the power element Q1 is shown in FIG. 11. However, this embodiment is not limited to this example. For example, the rectifying circuit for high-frequency power supply can have a configuration in which the diode D1 shown in any one of FIGS. 2 to 9 is replaced by the power element Q1. In this case, the rectifying circuit for high-frequency power supply can have a configuration which is an optimal one selected from among configurations in which the diode D1 shown in FIGS. 1 to 9 is replaced by the power element Q1, according to both the configuration (the output impedance) of the resonant type reception antenna 10, and the input impedance of a device which is connected to the output (DC output) of the rectifying circuit for high-frequency power supply.

Further, although the explanation is made as to the example shown in FIG. 11 by assuming that the constants of the inductor L11 and the capacitor C11 which construct the matching functional circuit are fixed and the resonance condition is fixed, this embodiment is not limited to this example. A variable resonance condition LC circuit 1 that causes the resonance condition to be variable can be used. Further, also in the configuration in which the diode D1 shown in any one of FIGS. 2 to 9 is replaced by the power element Q1, a variable resonance condition LC circuit 1 can be similarly applied.

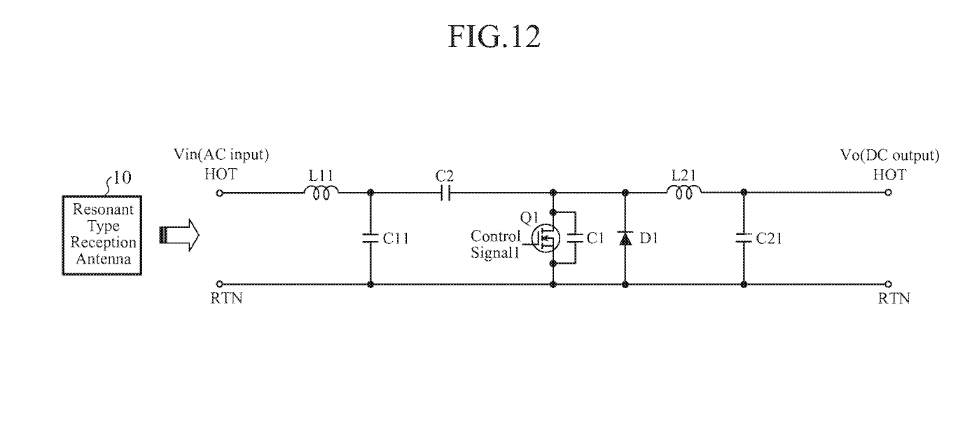

Further, the case in which the diode D1 is used as the rectifying element is shown in Embodiment 1 while the case in which the power element Q1 is used as the rectifying element is shown in Embodiment 2. In contrast with this, both the diode D1 and the power element Q1 can be used as the rectifying element as shown in FIG. 12. Although FIG. 12 shows the case in which the rectifying element shown in FIG. 1 is replaced by the rectifying element in which the diode D1 and the power element Q1 are used, this embodiment is not limited to this example. For example, the rectifying element shown in any one of FIGS. 2 to 9 can be replaced by the rectifying element in which the diode D1 and the power element Q1 are used. In addition, a variable resonance condition LC circuit 1 can be applied to any one of these configurations.

In addition, while the invention has been described in its preferred embodiments, it is to be understood that an arbitrary combination of two or more of the embodiments can be made, various changes can be made in an arbitrary component according to any one of the embodiments, and an arbitrary component according to anyone of the embodiments can be omitted within the scope of the invention.

### INDUSTRIAL APPLICABILITY

The rectifying circuit for high-frequency power supply according to the present invention can provide a high power conversion efficiency characteristic in the rectification of an alternating voltage at a high frequency equal to or higher than 2 MHz, and is suitable for use as a rectifying circuit for high-frequency power supply or the like that rectifies an alternating current power supply at a high frequency.

### EXPLANATIONS OF REFERENCE NUMERALS

1 variable resonance condition LC circuit, and 10 resonant type reception antenna (reception antenna for power transmission).

1] A rectifying circuit for high-frequency power supply that rectifies an alternating voltage at a high frequency equal to or higher 2 MHz, said rectifying circuit for high-frequency power supply comprising:
a class E rectifier circuit that rectifies said alternating voltage inputted from a reception antenna for power transmission;
a resonant circuit that causes said class E rectifier circuit to perform resonant switching in a switching operation at a time of rectification;
a matching functional circuit that has a function of matching a resonance condition to that of said reception antenna for power transmission, and a function of matching the resonance condition to that of said resonant circuit; and
a smoothing functional circuit that smooths the voltage rectified by said class E rectifier circuit into a direct voltage.

2] The rectifying circuit for high-frequency power supply according to claim 1, wherein said class E rectifier circuit is configured using a diode.

3] The rectifying circuit for high-frequency power supply according to claim 2, wherein said diode is one other than a diode for high frequency.

4] The rectifying circuit for high-frequency power supply according to claim 1, wherein said class E rectifier circuit is configured using a field effect transistor.

5] The rectifying circuit for high-frequency power supply according to claim 1, wherein said class E rectifier circuit is configured using a diode and a field effect transistor.

6] The rectifying circuit for high-frequency power supply according to claim 1, wherein said matching functional circuit matches the resonance condition to that of said reception antenna for power transmission according to magnetic-field resonance.

7] The rectifying circuit for high-frequency power supply according to claim 1, wherein said matching functional circuit matches the resonance condition to that of said reception antenna for power transmission according to electric-field resonance.

8] The rectifying circuit for high-frequency power supply according to claim 1, wherein said matching functional circuit matches the resonance condition to that of said reception antenna for power transmission according to electromagnetic induction.

9] The rectifying circuit for high-frequency power supply according to claim 1, wherein said matching functional circuit causes the resonance condition to be variable.
